(19) United States
(12) Patent Application Publication
(10) Pub. No.: US 2003/0228514 A1
(43) Pub. Date: Dec. 11, 2003

(54) Secondary cell

(75) Inventors: Yu-Ta Tu, Hsinchu Hsien (TW); Show-Jong Yeh, Hemet, CA (US)

Correspondence Address: BACON & THOMAS, PLLC, 625 SLATERS LANE, FOURTH FLOOR, ALEXANDRIA, VA, 22314

(73) Assignee: Sunyen Co., Ltd., Taipei (TW)

(21) Appl. No.: 10/170,716

(22) Filed: Jun. 14, 2002

(30) Foreign Application Priority Data
Jun. 7, 2002 (TW) 091112292

(51) Int. Cl. H01M 8/20

(52) U.S. Cl. 429/105; 429/204; 429/109

(57) ABSTRACT

In a secondary cell which generates a direct current when the positive electrode complex and the negative electrode complex thereof conduct a reversible redox reaction in the presence of an electrolyte, the positive electrode complex and the negative electrode complex are in a combination (represented by positive electrode complex/negative electrode complex) selected from the group consisting of lead/chromium complex, chromium complex/aluminum complex, and manganese complex/zinc complex. The secondary cell has relatively high capacitance and can be manufactured at low cost. Moreover, it provides more stable chemical reactions and can therefore be stably charged/discharged with large current and without risk of explosion.

### BACKGROUND OF THE PRESENT INVENTION

1. Field of the Invention

The present invention relates to a rechargeable secondary cell and, more particularly, to a secondary cell which has relatively high capacitance and stable charge/discharge current, which can be charged/discharged with reduced risk of explosion, and which can he manufactured at low cost. TV positive electrode complex and the negative electrode complex are in a combination selected from the group consisting of lead/chromium complex, chromium complex/aluminum complex, and manganese complex/zinc complex.

2. Description of the Related Art

As compared with a primary cell, a secondary cell is rechargeable and thus is environmentally friendly. A secondary cell can be recharged, for example, more than 500 times. Therefore, when the total service life is considered, a secondary cell would benefit the user.

Conventional secondary cells (or batteries), such as a nickel-cadmium cell, nickel-hydrogen hydride cell, lithium ion cell, etc, are well-known. The nickel-cadmium cell has been widely used in portable radios, remote controls, flash lights and the like. The nickel-hydrogen hydride cell can be used for replacing the nickel-cadmium cell and has a capacitance higher than that of the latter. Accordingly, the nickel-hydrogen cell has been widely used in cameras, mobile phones, portable computers and the like. The lithium ion cell has a capacitance higher than that of the nickel-hydrogen cell. Therefore, for example, an increasing number of mobile phones and portable computers use a lithium ion cell as the power supply. A lithium ion cell of standard size used for a mobile phone has a capacitance in the range of from 500 mAh to 700 mAh.

### SUMMARY OF THE INVENTION

The object of the present invention is, therefore, to provide a secondary cell which may generate a direct current when the positive electrode compound and the negative electrode compound thereof conduct a reversible redox reaction in the presence of an electrolyte, wherein the positive electrode complex and the negative electrode complex are in a combination (represented by positive electrode complex/the negative electrode complex) selected from the group consisting of lead/chromium complex, chromium complex/aluminum complex, and manganese complex/zinc complex. The secondary cell according to the present invention has relatively high capacitance, and more stable chemical reactions so that it can be stably charged/discharged without risk of explosion, with large current, and yet can be manufactured at low cost.

Other objects, features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof.

### BRIEF DESCRIPTION OF DRAWINGS

FIG. 1 is a schematic drawing of the lead-chromium secondary cell according to one preferred embodiment of the present invention;

FIG. 2 is a schematic drawing of the aluminum chromium secondary cell according to another preferred embodiment of the present invention; and

FIG. 3 is a schematic drawing of the manganese-zinc secondary cell according to still another preferred embodiment of the present invention.

### DETAILED DESCRIPTION OF PREFERRED EMBODIMENTS

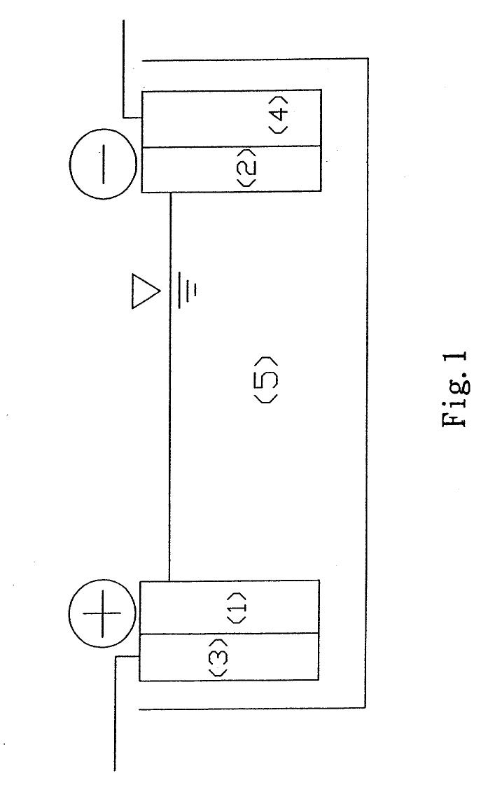

According to one embodiment of the present invention, a lead-chromium secondary cell is provided. Referring to FIG. 1, the lead-chromium secondary cell comprises lead as the positive electrode 1, a chromium complex as the negative electrode 2, a lead foil or lead alloy foil as the positive plate 3, a copper foil as the negative plate 4, a diluted sulfuric acid as the electrolyte 5, and a spacer (not shown) disposed between the positive and negative electrodes. By may of example, the positive electrode consists essentially of PbO₂ (0.1 to 0.5 mole) and a chelating agent (0.05-0.3 mole) and the negative electrode is chromium complex (0.05 to 0.3 mole). The electrolyte consists essentially of H₂SO₄ having a concentration of 10-50% and may include HCl. The reaction scheme of the charge/discharge thereof is as follows:

(Charge) 3PbSO₄+6H₂O+2Cr³⁺→3PbO₂+12H⁺+3SO₄²⁻+2Cr

(Positive electrode) PbSO₄+2H₂O→PbO₂+4H⁺+SO₄²⁻+2e⁻

(Negative electrode) Cr³⁺+3e⁻→Cr

During the charge, water is being consumed and the acid increases in concentration until the reaction is complete. Since the chromium for a chromium complex during the charge, it does not react and combine with the sulfate radical and thus the capacitance of the secondary cell can be significantly increased.

(Discharge) 3PbO₂+12H⁺+3SO₄²⁻+2Cr→3PbSO₄+6H₂O+2Cr⁺³

(Positive electrode) PbO₂+4H⁺+SO₄²⁻→PbSO₄+2H₂O

(Negative electrode) Cr→Cr⁺³+3e⁻

During the discharge of the lead-chromium cell, the acid decreases in concentration until any one of the sulfate radical and chromium is exhausted or the chromium complex has a saturated concentration.

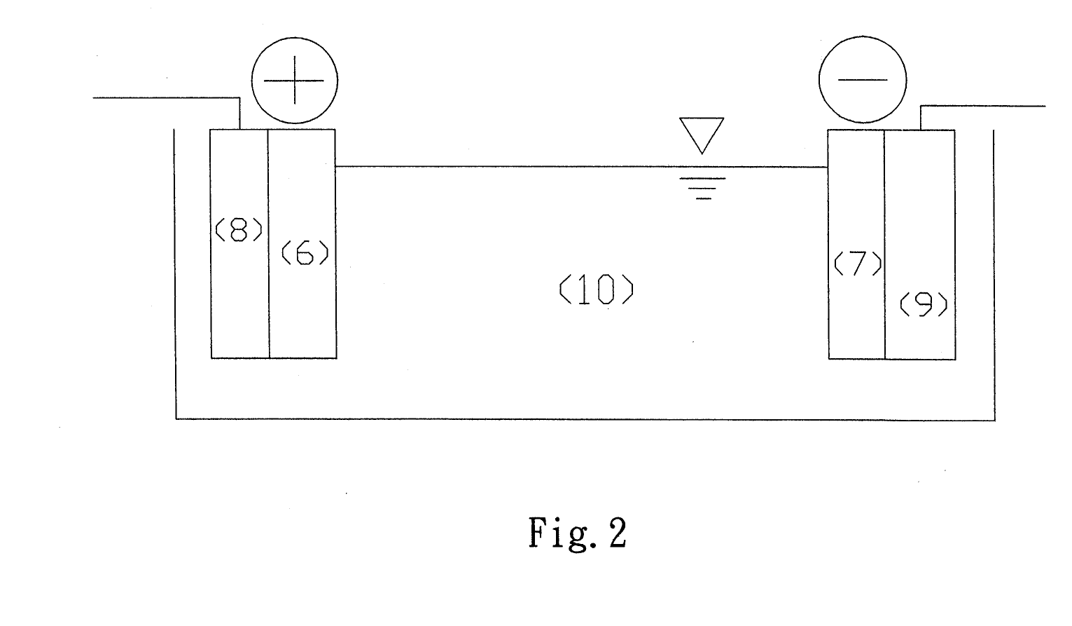

According to another embodiment of the present invention, an aluminum-chromium secondary cell is provided. Referring to FIG. 2, the aluminum-chromium secondary cell comprises a chromium complex as the positive electrode 6, an aluminum complex as the negative electrode 7, an aluminum foil as the positive plate 8, a copper foil as the negative plate 9, a diluted potassium hydroxide as the electrolyte 10, and a spacer (not shown) disposed between the positive and negative electrodes. By may of example, the positive electrode of this embodiment consists of Cr²⁺ (0.1-0.4 mole) and the negative electrode consists essentially of aluminum complex (0.1-0.4 mole); The KOH electrolyte has a preferred concentration of 5-40%. Those skilled in the art will appreciate that a chelating agent in an amount such as 0.05-0.3 mole may be included. The reaction scheme of the charge/discharge thereof is as follows:

(Charge) 2Cr²⁺+7H₂O+Al³⁺complex→Cr₂O₇²⁻+14H++2Al

(Positive electrode) 2Cr²⁺+7H₂O→Cr₂O₇²⁻+14H⁺+6e⁻

(Negative electrode) Al³⁺complex+3e⁻→Al

During the charge of the aluminum-chromium cell, hydroxide ion is formed, so that the electrolyte increases in hydroxide ion concentration until it reaches the original concentration.

(Discharge) Cr₂O₇²⁻+14H⁺+2Al→2Cr²⁺+7H₂O+Al³⁺complex

(Positive electrode) Cr₂O₇²⁻+14H⁺+6e⁻→Cr²⁺+7H₂O

(Negative electrode) Al→Al³⁺complex+3e⁻

During the discharge of the aluminum-chromium cell, the electrolyte decreases in hydroxide ion concentration until any one of the lead and chromate is completely reacted. When charged, overcharge should be avoided because it will result in the depletion of the water in the electrolyte and cause a short circuit.

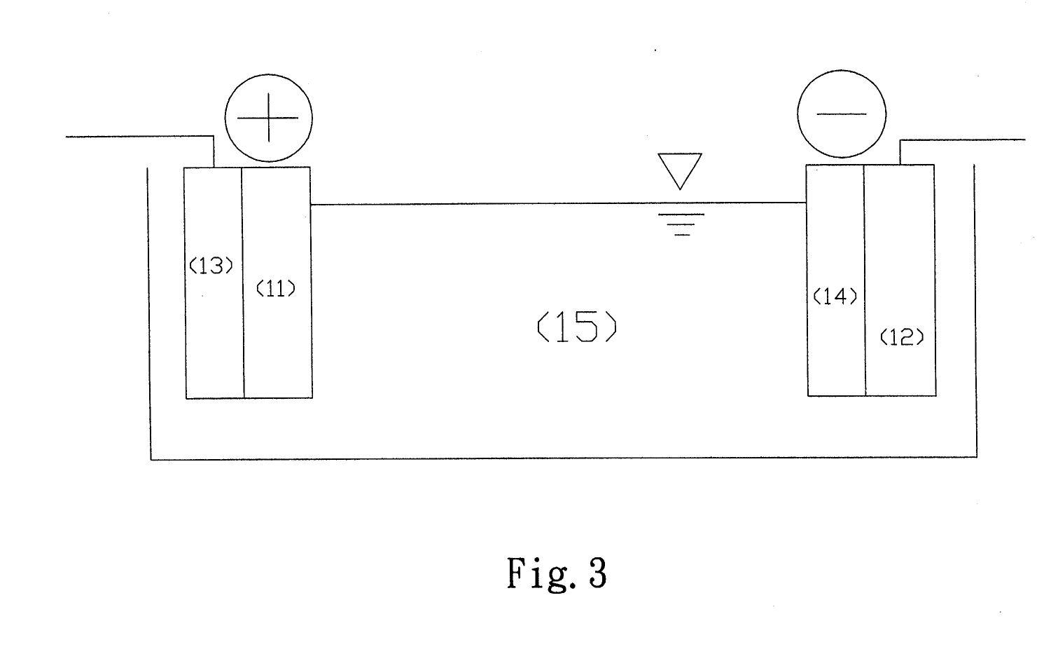

According to still another embodiment of the present invention, a manganese-zinc secondary cell is provided. Referring to FIG. 3, the manganese-zinc secondary cell comprises a manganese complex as the positive electrode 11, a zinc complex as the negative electrode 12, a lead foil as the positive plate 13, a copper foil as the negative plate 14, a diluted potassium hydroxide as the electrolyte 15, and a spacer (not shown) disposed between the positive and negative electrodes. The positive electrode preferably consists essentially of MnO₂ (0.05-0.2 mole) and negative electrode preferably consists essentially of Zinc complex (0.1-0.4 mole). A chelating agent in an amount such as 0.05 to 0.3 mole is preferably included. The KOH electrolyte may have a concentration of 5 to 30%. The reaction scheme of the charge/discharge thereof is as follows:

(Charge) 2Mn²⁺+5Zn²⁺complex+8H₂O→2MnO₄⁻+16H⁺+5Zn

(Positive electrode) Mn²⁺+4H₂O→MnO₄⁻+8H⁺+5e⁻

(Negative electrode) Zn²⁺complex+2e⁻→Zn

During the charge, the hydrogen ion and hydroxide ion ionized from the water will combine with zinc to form a hydrated zinc ion. The hydroxide ion concentration in the electrolyte should be controlled in order to avoid the occurrence of overcharge.

(Discharge) 2MnO₄⁻+16H⁺+5Zn→2Mn²⁺+Zn²⁺complex+8H₂O

(Positive electrode) MnO₄⁻+8H⁺+5e⁻→Mn²⁺+4H₂O

(Negative electrode) Zn→Zn²⁺complex+2e⁻

During the discharge of the manganese-zinc cell, the zinc will result in the occurrence of a hydrated ion or combine with hydrogen to form a zinc-hydrogen complex.

The invention is illustrated by the following examples.

### EXAMPLES

### Example 1

A lead-chromium secondary cell comprising lead as the positive electrode, a chromium complex as the negative electrode, a lead foil as the positive plate, a copper foil as the negative plate, a spacer disposed between the positive and negative electrodes, and a diluted sulfuric acid as the electrolyte was prepared. The secondary cell was made into a standard battery for an ordinary mobile phone. The resulting standard battery was fully charged. Thereafter, the capacitance and the discharge voltage thereof at room temperature were measured and had 800 mAh and 2.4 volts, respectively.

### Example 2

An aluminum-chromium secondary cell comprising a chromium complex as the positive electrode, an aluminum complex as the negative electrode, an aluminum foil as the positive plate, a copper foil as the negative plate, a spacer disposed between the positive and negative electrodes, and a diluted potassium hydroxide as the electrolyte was prepared. The secondary cell was made into a standard battery for an ordinary mobile phone. The resulting standard battery was fully charged. Thereafter, the capacitance and the discharge voltage thereof at room temperature were measured and had 2000 mAh and 3.0 volts, respectively.

### Example 3

A manganese-zinc secondary cell comprising a manganese complex as the positive electrode, a zinc complex as the negative electrode, a lead foil as the positive plate, and a copper foil as the negative plate, a spacer disposed between the positive and negative electrodes, and a diluted potassium hydroxide as the electrolyte was prepared. The secondary cell was made into a standard battery for an ordinary mobile phone. The resulting standard battery was fully charged. Thereafter, the capacitance and the discharge voltage thereof at room temperature were measured and had 2000 mAh and 2.4 volts, respectively.

It can be seen from the results of the above examples and descriptions that a secondary cell, according to the present invention has relatively high capacitance and can be manufactured at low cost. Moreover, it is used safely and can be stably charged/discharged with large current.

What is claimed is:

1. A secondary cell, comprising a positive electrode complex, a negative electrode complex and an electolyte, wherein said positive electrode complex and negative electrode complex are in a combination selected from the group consisting of lead/chromium complex, chromium complex/aluminum complex, and manganese complex/zinc complex.

2. The secondary cell according to claim 1, wherein the positive electrode complex/negative electrode complex are lead/chromium complex.

3. The secondary cell according to claim 1 further comprising a lead foil as the positive plate, and a copper foil as the negative plate.

4. The secondary cell according to claim 2 or 3, wherein the electrolyte is a sulfuric acid.

5. The secondary cell according to claim 1, wherein the positive electrode complex/negative electrode complex are chromium complex/aluminum complex.

6. The secondary cell according to claim 1 further comprising an aluminum foil as the positive plate and a copper foil as the negative plate.

7. The secondary cell according to claim 5 or 6, wherein the electrolyte is a potassium hydroxide.

8. The secondary cell according to claim 1, wherein the positive electrode complex/negative electrode complex are manganese complex/zinc complex.

9. The secondary cell according to claim 1 further comprising a lead foil as the positive plate and a copper foil as the negative plate.

10. The secondary cell according to claim 8 or 9, wherein the electrolyte is a potassium hydroxide.
